(19) United States
(12) Patent Application Publication
(10) Pub. No.: US 2017/0294654 A1
(43) Pub. Date: Oct. 12, 2017

(54) Rechargeable magnesium ion battery with nanoporous-carbon electrode for reversible magnesium ion intercalation

(71) Applicant: Sandia Corporation, Albuquerque, NM (US)

(72) Inventors: Michael P. Siegal, Albuquerque, NM (US); William G. Yelton, Sandia Park, NM (US)

(21) Appl. No.: 15/457,598

(22) Filed: Mar. 13, 2017

Related U.S. Application Data
(60) Provisional application No. 62/318,915, filed on Apr. 6, 2016.

(51) Int. Cl. H01M 4/587; H01M 4/38; H01M 10/054

(52) U.S. Cl. CPC H01M 4/587; H01M 10/054; H01M 4/381; H01M 2300/0025

(57) ABSTRACT

Nanoporous-carbon grown via pulsed laser deposition can be used as an electrically conductive anode host material for Mg²⁺ intercalation in rechargeable magnesium batteries. Nanoporous carbon has high surface area, and an open, accessible pore structure tunable via mass density that can improve diffusion. A preferred nanoporous carbon mass density of about 0.5 g/cm³ does not mechanically degrade with successive insertion/de-insertion cycles and provides an average interplanar spacing between graphene sheet fragments of greater than about 4.8 Å, large enough for reversible intercalation of partially-solvated Mg²⁺.

### CROSS-REFERENCE TO RELATED APPLICATION

This application claims the benefit of U.S. Provisional Application No. 62/318,915, filed Apr. 6, 2016, which is incorporated herein by reference.

### STATEMENT OF GOVERNMENT INTEREST

This invention was made with Government support under contract no. DE-AC04-94AL85000 awarded by the U. S. Department of Energy to Sandia Corporation. The Government has certain rights in the invention.

### FIELD OF THE INVENTION

The present invention relates to rechargeable batteries and, in particular, to a rechargeable magnesium ion battery with a nanoporous-carbon electrode for reversible magnesium ion intercalation.

### BACKGROUND OF THE INVENTION

Rapidly expanding energy demands have intensified research on high-performance batteries, regarded as a key enabler for extended range electric vehicles and smart energy grids. The electrochemical energy storage performance for Li-ion chemistry is limited by its single electron valence. Developing multivalent battery chemistries, such as Mg²⁺, is a potential pathway toward increasing energy density, driven by the greater number of electrons transferred per metal cation. A rechargeable battery with active Mg metal as an anode is a natural choice, and the first prototype was based on two significant breakthroughs: a non-Grignard Mg-complex electrolyte with sufficient anodic stability allowing fully-reversible Mg electrodes, and chevral (Mo₆S₈) phase-based high rate Mg cathodes. See D. Aurbach et al., Nature 407, 724 (2000). Nevertheless, Mg rechargeable batteries based on Mg anodes have yet to successfully commercialized due to a low energy density that suffers from the low working voltage and limited cathode capacity. See D. Aurbach et al., Adv. Mater. 19, 4260 (2007); and H. D. Yoo et al., Energy & Environmental Science 6, 2265 (2013).

Conventional electrolytes cannot be used in Mg rechargeable batteries due to a thermodynamically stable Mg²⁺ blocking layer that forms on Mg metal making the anode function irreversibly. See J. Muldoon et al., Energy Environ. Sci. 5, 5941 (2012). While Grignard reagents (RMgX, where R is an alkyl group and X is Cl or Br) prevent passivation of Mg metal anodes by permitting Mg to reversibly deposit and dissolve on the Mg electrode, they are nevertheless not suitable for battery use due to being pyrophoric. See C. Liebenow, J. Appl. Electrochem. 27, 221 (1997); and J. H. Connor et al., J. Electrochem. Soc. 104, 38 (1957). The current state-of-the-art organohaloaluminate electrolytes, Mg(AlCl₃R)₂ and Mg(AlCl₂RR′)₂, where R and R′ are alkyl groups, allow reversible Mg metal electrodes at low overpotentials. However, these non-conventional electrolytes have a narrow electrochemical window (˜2 V vs. Mg/Mg²⁺) that limits the operation voltage and the choice of cathode materials. See D. Aurbach et al., Nature 407, 724 (2000); J. Muldoon et al., Energy Environ. Sci. 5, 5941 (2012); and N. Amir et al., J. Power Sources 174, 1234 (2007).

Therefore, a need remains for a rechargeable magnesium battery.

### SUMMARY OF THE INVENTION

The present invention is directed to a rechargeable magnesium battery, comprising a positive electrode; a negative electrode comprising nanoporous carbon; and an electrolyte for movement of magnesium ions from the positive electrode to the negative electrode during charging and from the negative electrode to the positive electrode during discharging. The nanoporous carbon can have a density of greater than 0.25 g/cm³ and less than 1.0 g/cm³. The preferred nanoporous carbon mass density is the lowest density that does not mechanically degrade with successive insertion/de-insertion cycle, or about 0.5 g/cm³. For reversible intercalation of magnesium ions into the negative electrode, the nanoporous carbon can have an average interplanar spacing between graphene sheet fragments of greater than about 4.8 Å. For example, the positive electrode can comprise magnesium metal. For example, the electrolyte can comprise a magnesium organohaloaluminate, such as a dichor-complex electrolyte.

### BRIEF DESCRIPTION OF THE DRAWINGS

The detailed description will refer to the following drawings, wherein like elements are referred to by like numbers.

FIG. 1 is a schematic illustration of a coin cell battery.

FIGS. 2(a)-(c) are SEM images showing the surface morphology of NPC films grown using PLD in p(Ar) of 150 mTorr (FIG. 2(a)), 200 mTorr (FIGS. 2(b)), and 240 mTorr (FIG. 2(c)).

FIGS. 3(a)-(c) are SEM images of cleaved NPC/Si(100) samples used to measure the thickness of each film, where the p(Ar) used during PLD is 150 mTorr (FIG. 3(a)), 200 mTorr (FIGS. 3(b)) and 240 mTorr (FIG. 3(c)).

FIG. 4 is a graph of NPC mass density plotted as a function of p(Ar) used during PLD. The dashed line is intended only as a guide-to-the-eye.

FIG. 5(a) is a plot of N₂ adsorption isotherms at 77 K for NPC films grown using different p(Ar). FIG. 5(b) is a plot of NPC surface area calculated from curves in (a) using the BET method as a function of NPC mass density. The solid line is intended only as a guide-to-the-eye. The dashed line is a linear extrapolation of the highest density samples to a hypothetical zero mass density.

FIG. 6 is a plot of CV scans for NPC anode with density ˜1.0 g/cm³. Potential is plotted vs. Mg:Mg²⁺. The anode areal density was 0.10±0.01 mg/cm². The scan rate was 0.5 mV/s.

FIG. 7 is a plot of CV scans for NPC anode with density ˜1.0 g/cm³. Potential is plotted vs. Mg:Mg²⁺. The anode areal density was 0.10±0.01 mg/cm². The scan rate was 1.0 mV/s.

FIG. 8 is a plot of CV scans for NPC anode with density ˜0.5 g/cm³. Potential is plotted vs. Mg:Mg²⁺. The anode areal density was 0.10±0.01 mg/cm². The scan rate was 0.1 mV/s.

FIG. 9 is a plot of CV scans for NPC anode with density ˜0.06 g/cm³. Potential is plotted vs. Mg:Mg²⁺. The anode areal density was 0.14±0.02 mg/cm². The scan rate was 0.1 mV/s.

### DETAILED DESCRIPTION OF THE INVENTION

Intercalation is the reversible inclusion or insertion of ions into a host solid having a layered structure, such as graphite intercalation compounds. Intercalation expands the van der Waals gap between sheets, which requires energy. Usually this energy is supplied by charge transfer between the inserted ion and the host solid, i.e., a redox reaction. In a rechargeable battery, the redox reactions at the electrodes are reversible and ions move from the positive electrode (cathode) and are inserted (intercalated) into the negative electrode (anode) during charging and are de-inserted from the anode and move back to the cathode when discharging. The electrolyte allows for ionic movement between the two electrodes. Replacing Mg metal anodes with Mg-ion intercalation anodes should negate the challenge posed by the passivation surface film on the metal anode since no formal electron transfer is required. An intercalation anode would also enable the use of conventional electrolytes, which normally have high anodic stability (3-5 V), hence allowing the use of high-capacity, high-voltage cathodes. Furthermore, intercalation anode cell designs can benefit from lessons learned from Li-ion batteries, perhaps somewhat reducing the risk of system level development. See K. G. Gallagher et al., Energy & Environmental Science 7, 1555 (2014).

Reversible electrochemical intercalation is well established for Li ions into graphitic carbon host materials, but has not been demonstrated for alkaline earth metals. See J. R. Dahn et al., Science 270, 5236 (1995). However, multivalent ion graphite intercalation compounds have been formed by vapor phase treatment, suggesting that such intercalation is not limited by thermodynamics but rather by the energetics and kinetics of multivalent ion delivery to and into the interlayer spacing of a carbon host that is challenged by the high charge/radius ratio of multivalent ions. See S. Heguri and M. Kobayashi, J. Phys. and Chem. Solids 71, 572 (2010); M. Kawaguchi and A. Kurasaki, Chem. Comm. 48, 6897, (2012); and S. Deng et al., Angewandte Chemie International Ed. 47, 6703 (2008). These difficulties are further hampered by what appears to be an incomplete de-solvation of Mg²⁺ from the electrolyte molecule upon arrival at the surface of an intercalation material. See H. D. Yoo et al., Energy & Environmental Science 6, 2265 (2013). Since interfacial structures likely dictate the intercalation processes, expanded graphitic interlayer spacing should positively impact the intercalation barrier and solid-state diffusion of multivalent ions within the carbon host. Essentially, wider passage channels between graphene sheets should improve the solid-state diffusion kinetics.

Very little progress has been made for multivalent energy storage via intercalation into existing carbonaceous materials due to insufficient interstitial/interplanar spacing within the crystallographic structures to host the larger sizes of partially-solvated multivalent ions. To improve Mg-ion intercalation anode chemistries, the present invention is directed to a novel class of internally nanostructured carbon materials with tailored interlayer spacings, using nanoporous-carbon (NPC) as an electrically conductive intercalation host material. NPC can be grown via pulsed-laser deposition (PLD) with controllable mass densities ranging from ˜0.05 to 2.0 g/cm³. See M. P. Siegal et al., Appl. Phys. Lett. 80, 3940 (2002). The internal structure of NPC self-assembles during growth and consists of nano-fragments of aligned graphene sheet stacks that have interplanar spacings expanded by as much as 55% compared to crystalline graphite. NPC is sufficiently disordered such that θ-2θ x-ray diffraction yields no crystalline peaks. Indeed, typical crystalline domain sizes are only 1-2 nm in length, as determined by high-resolution transmission electron microscopy; hence, NPC consists of randomly-oriented graphene nano-crystallites with expanded interplanar spacings, and with a plethora of grain boundaries to enable rapid diffusion of species into an entire volume. Reducing the mass density of NPC increases the interplanar spacings. See M. P. Siegal et al., Langmuir 20, 1194 (2004). NPC with density ˜1 g/cm³ has been robustly tested and used for commercial chemical sensors, as well as having a very high electrochemical specific capacitance compared to other known carbon nanomaterials. See M. P. Siegal and W. G. Yelton, Adv. Sci. and Technol. 48, 161 (2006); M. P. Siegal et al., J. Electrochem. Soc. 162, B114 (2015); and S. J. Limmer et al., ECS Trans. 28, 89 (2010).

Another advantage of using NPC for Mg²⁺ intercalation includes the tunability of the interplanar spacings and the ability to deposit it onto any substrate material without using binder materials, both increasing the fraction of available carbon surface atoms and simplifying the interpretation of measurements. For example, while crystalline graphite has an interplanar spacing of 3.35 Å between graphene sheets, this spacing increases as a function of decreasing NPC mass density: NPC with densities 1.0 and 0.25 g/cm³ have average interplanar spacings 4.6±0.2 Å and 5.2±0.2 Å, respectively. Note that these values, measured using high-resolution transmission electron microscopy, are nearly perfectly linear with that for crystalline graphite. See M. P. Siegal et al., Langmuir 20, 1194 (2004). Accordingly, NPC can be used as a binderless intercalation host for multivalent energy storage.

As an example of the invention, NPC was grown with mass densities ranging from 0.06-1.3 g/cm³ and characterized as an anode intercalation host in a simple Mg²⁺ coin cell battery. Three distinct patterns of electrochemical behavior were identified for the different NPC mass densities that correlate to classic charge/discharge currents generated from parallel plate capacitors to asymmetric voltammograms analogous to double layer surface charging. Cyclic voltammetry (CV) was used to determine that a NPC with density ˜0.5 g/cm³, corresponding to an average interplanar spacing between graphene sheet fragments ˜5 Å, demonstrates a behavior associated with Mg²⁺ intercalation into the NPC anode.
NPC Preparation

NPC was grown via PLD directly onto 2 cm-diameter SUS316L stainless steel disks or Si(100) substrates cut to various sizes. Pulsed 248-nm excimer laser radiation (KrF) was focused to ablate a rotating pyrolytic graphite target with energy density just above the ablation limit ˜1.5 J/cm². With base pressure <10⁻⁷ Torr, Ar gas, ranging from p(Ar)=140-320 mTorr, was introduced into the PLD vacuum chamber during growth to further attenuate the kinetic energy of the ablated species. As p(Ar) increases, the kinetic energy of the ablated species decreases, resulting in lower NPC mass densities with inherently larger pore sizes and interplanar spacing between graphene sheet fragments, and hence, larger surface areas. Each film deposition was for a constant carbon mass per unit area ˜0.11±0.02 mg/cm². This allows direct comparison of mass density and surface area with the electrochemical measurements.

The depositions onto the Si substrates were used to measure the NPC mass density for each p(Ar) condition and to perform Brunauer-Emmett-Teller (BET) surface area measurements for samples grown in p(Ar)=140-280 mTorr. See S. Brunauer et al., J. Am. Chem. Soc. 60, 309 (1938). Si pieces cut to 19 mm×7.5 mm for mass density measurements were weighed before and after deposition using a microbalance that recorded mass to tenths of micrograms. Film thicknesses were determined by cleaving the NPC-coated Si(100) samples and measuring the cross-sectional film thickness using scanning electron microscopy (SEM). A 3.5% uncertainty is based on the spread of thickness measurements at different cross-sectional positions for a given sample, leading to a 7.8% uncertainty for the density determinations. For BET analysis, films were simultaneously grown on two 25 mm×9 mm Si pieces at each p(Ar) to generate sufficient carbon mass for the absorption studies. These films were then cross-sectioned and measured in the SEM for thickness so that the exact mass density for the BET samples could be specified. Since all of the films had similar total carbon mass deposition, lower mass density NPC films have greater thickness than higher density films. A previous study has shown that low density NPC is not defined primarily by large pores or high pore densities, but rather by a greater average interplanar spacing between graphene sheet fragments. See M. P. Siegal et al., Langmuir 20, 1194 (2004).
Coin Cell Fabrication

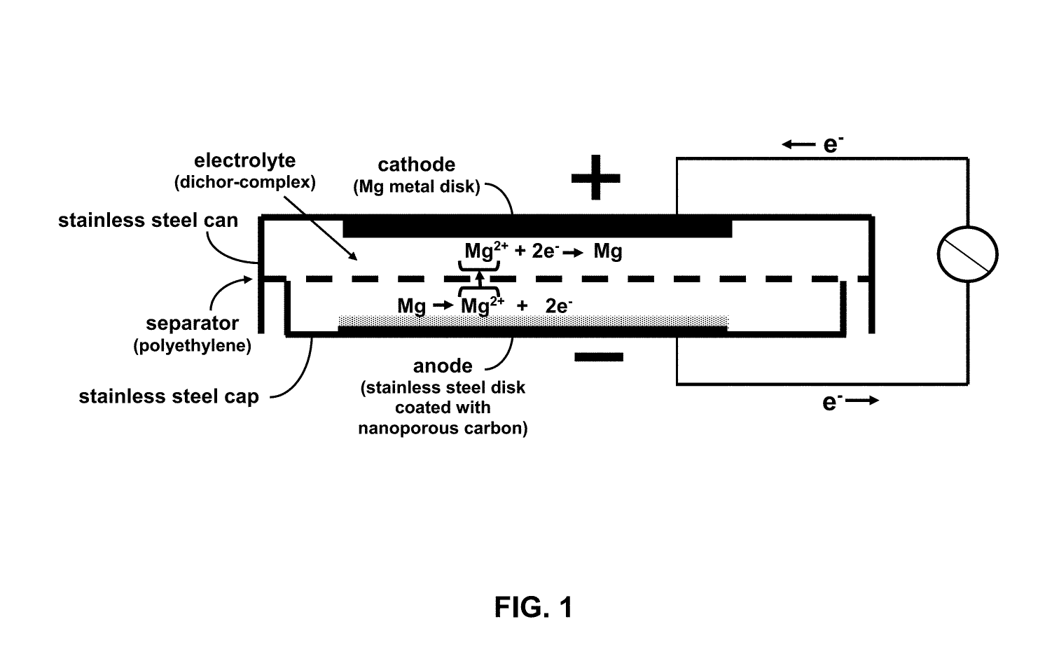

A schematic illustration of an exemplary rechargeable magnesium coin cell battery during discharge is shown in FIG. 1. Coin cells were fabricated in a dry argon purged glove box with O₂ and H₂O levels below 0.5 ppm. The anode and cathode assemblies were constructed separately before being put together into a sealed coin cell. The anode comprised a stainless steel cap, polypropylene seal, stainless steel disk, and stainless steel flat spring. NPC films were deposited directly onto the stainless steel disk as the working anode for the battery (as shown). The cathode consisted of a stainless steel can, Mg metal disk, and polyethylene separator. The Mg metal served as both the cathode and quasi-reference for the battery. 500 μL of electrolyte solution, 0.5 M magnesium organohaloaluminate salt (Grignard type) diluted in tetrahydrofuran (THF), was added to the cathode can prior to sealing the two pieces together. The dichor-complex (DCC) electrolyte was synthesized by reacting 1 M dibutylmagnesium in heptane and 0.9 M ethyl dichloride in heptane in a 1:2:2 molar ratio under flowing Ar. The ethyl dichloride was chilled to −20 ° C. to control the exothermic reaction and maintain slow reaction rates. The reaction resulted in a white precipitate. The heptane was removed under vacuum and the precipitate was resolvated in THF. Before assembly, all NPC films were dried and outgassed in the glove box for at least 48 hours. The glove box monitors showed both the O₂ and H₂O levels to be below 0.4 ppm. Regardless, before assembling the cathode, the Mg disks were wire brushed in the glove box to physically remove surface oxides. Samples underwent electrochemical testing within 24-48 hours of removal from the glove box. However, since Grignard reagents react readily with water, it is unlikely that any water remains in the electrolyte.
NPC Morphology

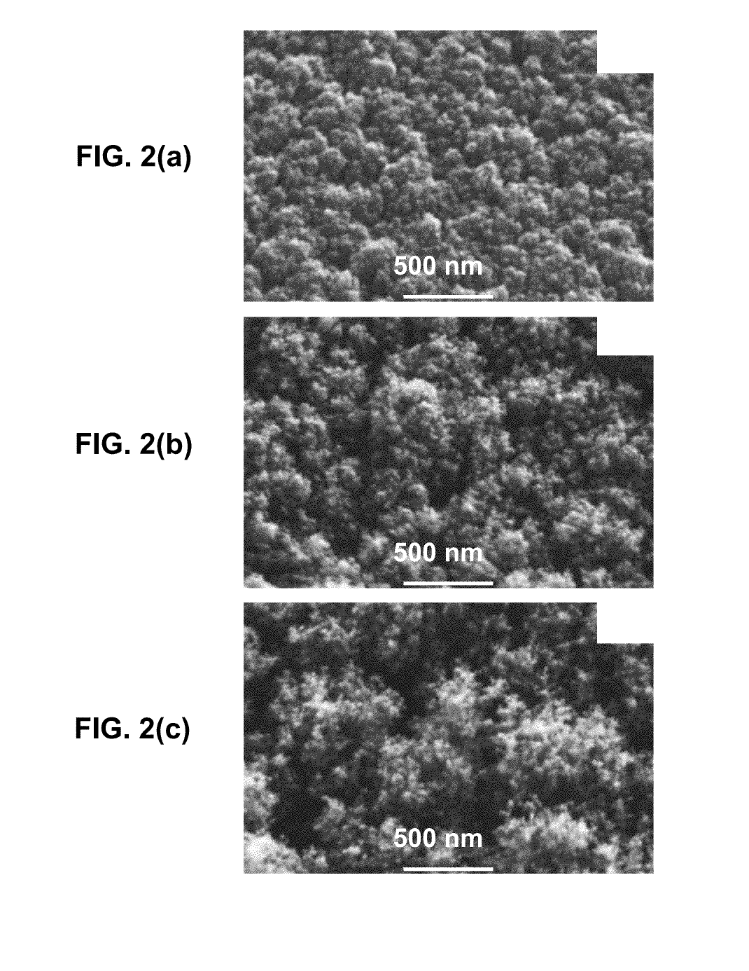

FIGS. 2(a)-(c) are SEM images showing the morphology of a selected few NPC films grown in p(Ar)=150, 200 and 240 mTorr. These films consist of nearly the same total carbon mass, hence the apparent differences in their morphologies are due solely to their different mass densities. While the surface of each film should be considered as ‘rough’, the degree of surface roughness, or the development of smaller clusters spaced further apart, clearly increases as a function of increasing p(Ar) during PLD.

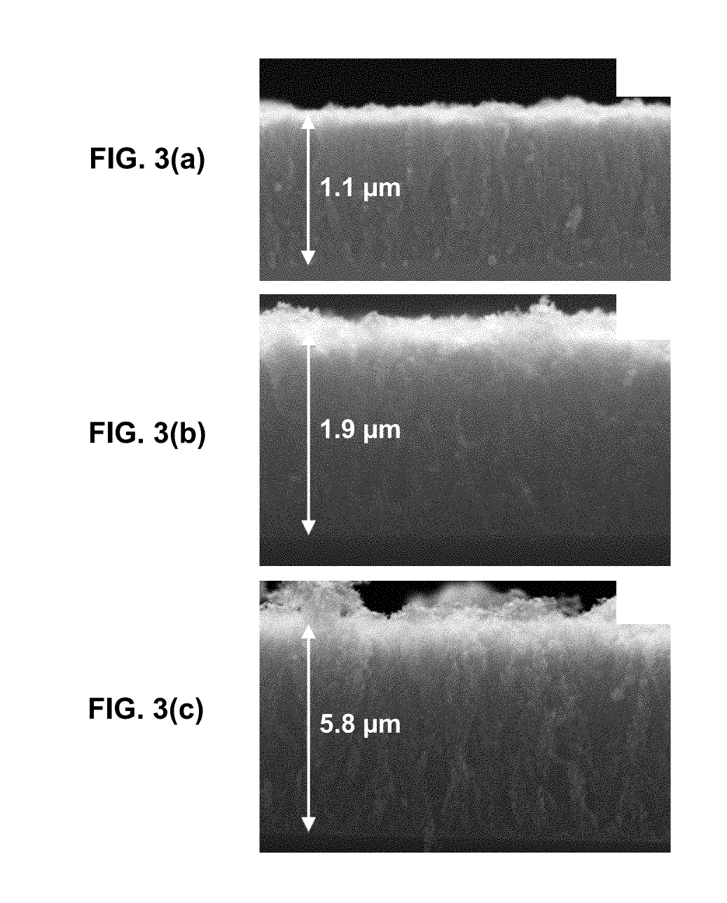

FIGS. 3(a)-(c) show cross-sectional images obtained by cleaving the samples shown in FIGS. 2(a)-(c). Again, each sample has nearly the same total carbon mass, hence the differences in film thickness are directly due to their different mass densities. Lower magnification was required with increasing p(Ar) during PLD in order to fit the entire film cross-section in a single image. The film grown in p(Ar)=150 mTorr, FIG. 3(a), shows less internal structure then those grown in higher p(Ar), indicative of a higher mass density. Conversely, the film grown in the p(Ar)=240 mTorr, FIG. 3(c), shows the most internal structure, inferring the lowest mass density. Similar images were obtained for every NPC film studied in order to calculate the mass densities.
NPC Mass Densities

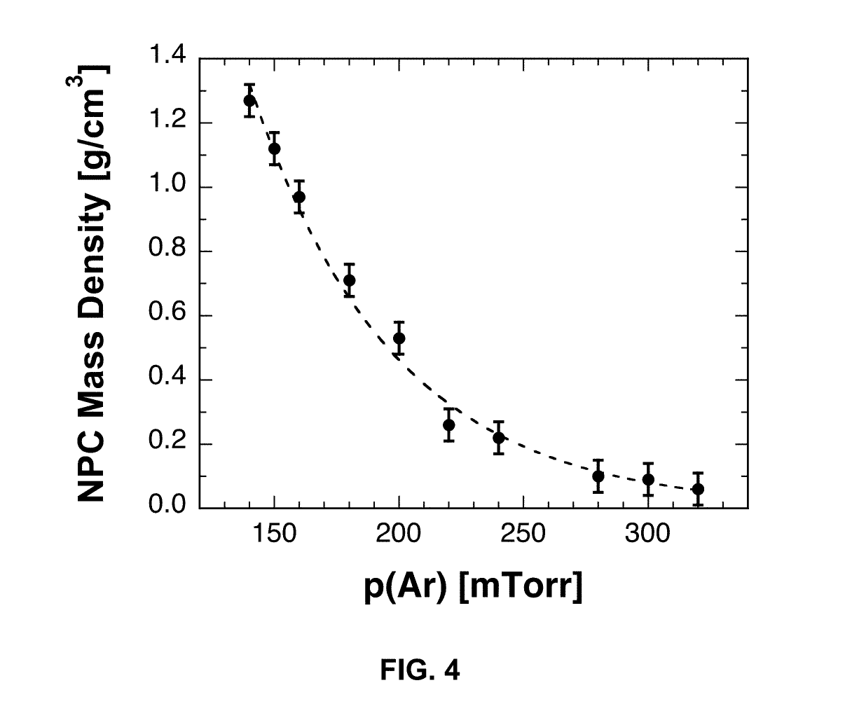

Using the actual measured areal mass densities for each film, along with the measured thicknesses from the cross-section images in FIGS. 3(a)-(c), it is possible to directly calculate the mass density for each film as a function of p(Ar). This result is plotted in FIG. 4. Additional films were also measured, not shown in FIGS. 2(a)-(c) or 3(a)-(c). From 140 to 320 mTorr there is a clear monotonic decrease in mass density as a function of the p(Ar) used during PLD, ranging from values near 1.3 g/cm³ to below 0.1 g/cm³, a drop greater than a full order of magnitude. While the film densities continue to decrease with the use of even higher p(Ar) during PLD, the rate of change is significantly lower. The lowest NPC mass density measured was 0.06 g/cm³.
BET Specific Surface Area

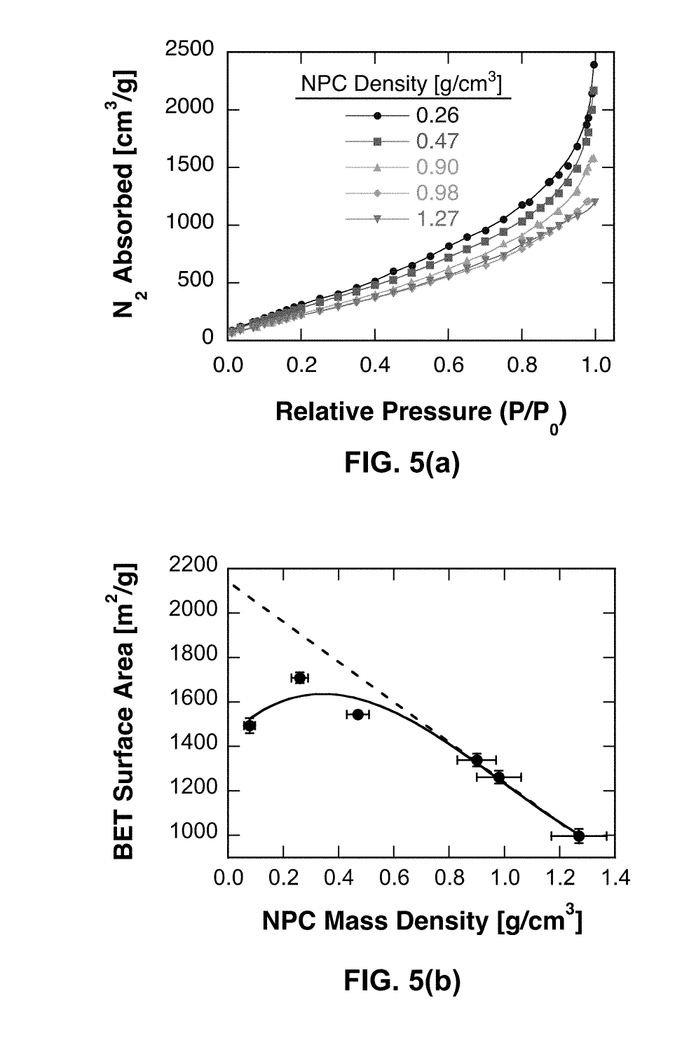

Samples for BET characterization were grown at p(Ar)=140, 160, 180, 200, 220 and 280 mTorr, and had mass densities of 1.27, 0.98, 0.90, 0.47, 0.26 and 0.08 g/cm³, respectively. Only the NPC film masses were considered in the BET specific surface area measurements calculations; all substrate contributions are considered negligible and were excluded. The nitrogen adsorption isotherm at 77 K for each NPC sample, except that grown at p(Ar)=280 mTorr, is shown in FIG. 5(a). The shapes of these curves are similar to those reported elsewhere for various types of carbon nanotubes, another pure sp² carbon bonded material. See F. Li et al., Carbon 42, 2375 (2004). The isotherm for the 0.08 g/cm³ film is nearly identical to that shown for the 0.47 g/cm³ film; hence, it is not shown here for clarity.

A standard BET measurement requires at least 3 points to fit a linear plot, in a P/Po range of 0.05 to 0.35 on a nitrogen adsorption isotherm. See S. Lowell et al., in “Characterization of Porous Solids and Powders: Surface Area, Pore Size and Density”, Kluwer Academic Publisher, Dordrecht, 2004, Springer (2006). In these experiments, the best fits were obtained in 0.07-0.21 P/P₀ range. FIG. 5(b) shows the calculated BET surface areas. The solid line is merely a guide-for-the-eye. Surface area increases with decreasing NPC mass density for all but the lowest density film studied, ranging from 997±32 m²/g to 1,709±24 m²/g for samples with mass densities ranging from 1.27-0.26 g/cm³, respectively. These variations in surface area with mass density imply different hierarchical structures within the carbon framework, consistent with the high-resolution transmission electron microscopy images of similar NPC samples in Siegal et al. See M. P. Siegal et al., Langmuir 20, 1194 (2004). Note that the surface area for the lowest density film studied is similar (slightly lower) to that for the 0.47 g/cm³ density sample, consistent with their nearly identical isotherms. Overall, such values are mostly higher than those reported for various other carbon materials. For example, while the surface area of a single graphene sheet is 2,630 m²/g, chemically-modified graphene agglomerates used for graphene-based ultracapacitors report a BET surface area of only 705 m²/g. See M. D. Stoller et al., Nano Lett. 8, 3498 (2008).

Ordered mesoporous carbons have 1,500-1,800 m²/g surface areas, similar to the NPC results, however such materials typically have extremely low mass densities <0.1 g/cm³ due to the nature of their porosity. See R. Ryoo et al., Adv. Mater. 13, 677 (2001). Carbon nanotube bundles have BET surface areas ranging from 200-600 m²/g depending on tube diameters and other structural characteristics. See F. Li et al., Carbon 42, 2375 (2004). So while both graphene and nanotubes have very high individual surface areas, in agglomerates and bundles most of the measureable surface area is diminished.

The dashed line in FIG. 5(b) is a linear extrapolation of the surface areas from the three highest density films measured. The lower mass density film surface area values falling below this dashed line infers that the structural integrity of NPC films may be weakening with mass densities somewhere below 0.75-0.90 g/cm³. This is consistent with an earlier report studying these materials as a chemical absorbent coating on surface-acoustic-wave devices that reported films grown in p(Ar) 180 mT, corresponding to mass densities 0.9 g/cm³, led to reduced acoustic wave transfer across the film surface. See M. P. Siegal et al., J. Electrochem. Soc. 162, B114 (2015). This does not suggest that such lower density films are not appropriate for Mg ion energy storage, only that there may be some density limit below which the films will not be able to support reversible mass transfer due to such mechanical degradation.

Lastly, it is interesting to note that the ˜2,170 m³/g extrapolated surface area of NPC in the hypothetical limit of zero mass density is >80% the theoretical graphene limit. While itself a nonphysical result, this high value perhaps provides further confirmation of the remarkable topological homogeneity of NPC since such high surface area values for the given mass densities can only be achieved with great uniformity throughout the entire film structures. Clearly, NPC is nanostructured differently than previously reported forms of disordered carbon.
Coin Cell Performance as a Function of NPC Mass Density

The coin cell configuration served as the working container for the electrochemical measurements. The working electrode was a 1.98 cm² stainless steel disk coated with NPC. The counter electrode was a Mg metal disk with the same dimensions. A quasi-reference point was established from the Mg metal electrode (Mg:Mg²⁺ DCC, 0 mV vs. Mg). The open circuit potential and resistance for every coin cell was measured following fabrication, as well as following every electrochemical measurement. Typical open circuit potentials for these batteries ranged from 1.4-1.9 V, with cell resistances ranging from 3.5-6.0 MΩ. Such variation is anticipated due to both varying the NPC mass density used in the anodes, as well as variability resulting from the cell-to-cell fabrication process.

Cyclic voltammetry (CV) scans were performed for each coin cell at a scan rate of 100-500 μV/s. The open circuit potential was stabilized to drifts <2 mV/min before starting each scan. All CV data were collected with potentials progressing negative from that of the open circuit. The scans were bound positive of 0 mV vs. the quasi-reference Mg to 2 V vs. the reference. At least four CV cycles were measured for each coin cell.

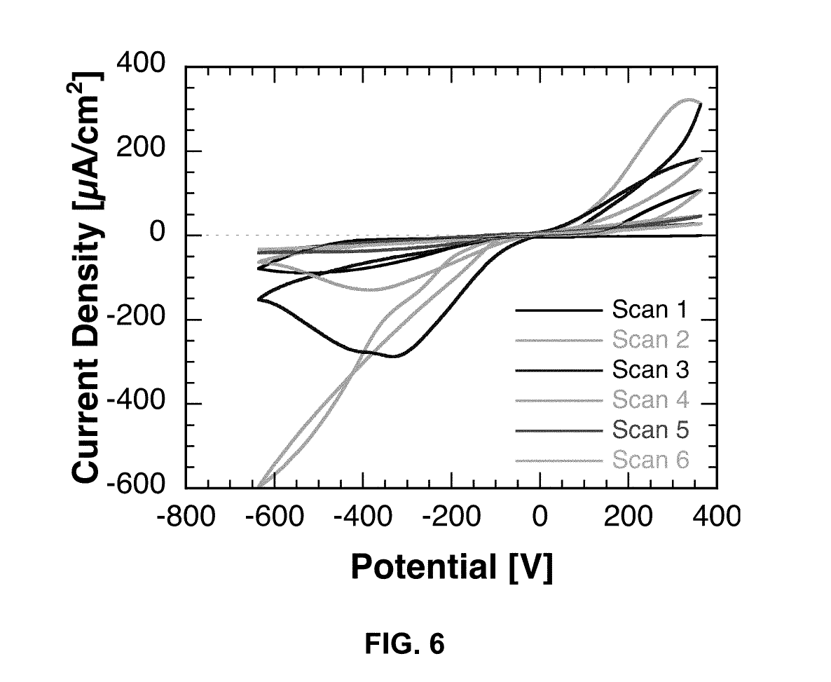

FIG. 6 is a CV taken for a coin cell fabricated using the densest NPC film studied, at 0.97 g/cm³. The initial open circuit potential (OCP) was +1.6 V vs. Mg:Mg²⁺. The cell was swept cathodically without showing any current density response until negative potentials were reached. The cell then shows a strong negative current density, implying Mg metal deposition onto the NPC anode material. Reversing the potential sweep nearly follows the original current density up to 0 V, indicating continued Mg deposition under these conditions. The rate of Mg deposition appears to be proportional to the drive potential. The shape of this CV is consistent with that shown for Mg electrodeposition onto a Pt working anode. See Y. Orikasa et al., Sci. Rep. 4, 5622 (2014). Under anodic stripping conditions positive of 0 V, there is a small charge recovery likely due to a small portion of the Mg coating being removed from the NPC, however the bulk of the coating appears to remain. Furthermore, the OCP shifts from +1.6 V to 0 V once Mg deposition takes place, further evidence for ‘permanent’ Mg deposition onto the NPC film. Each ensuing CV scan results in a decreasing current density, both anodically and cathodically, implying that driving the potential to negative values results in Mg metal surface deposition, preventing Mg ions from diffusing into the NPC.

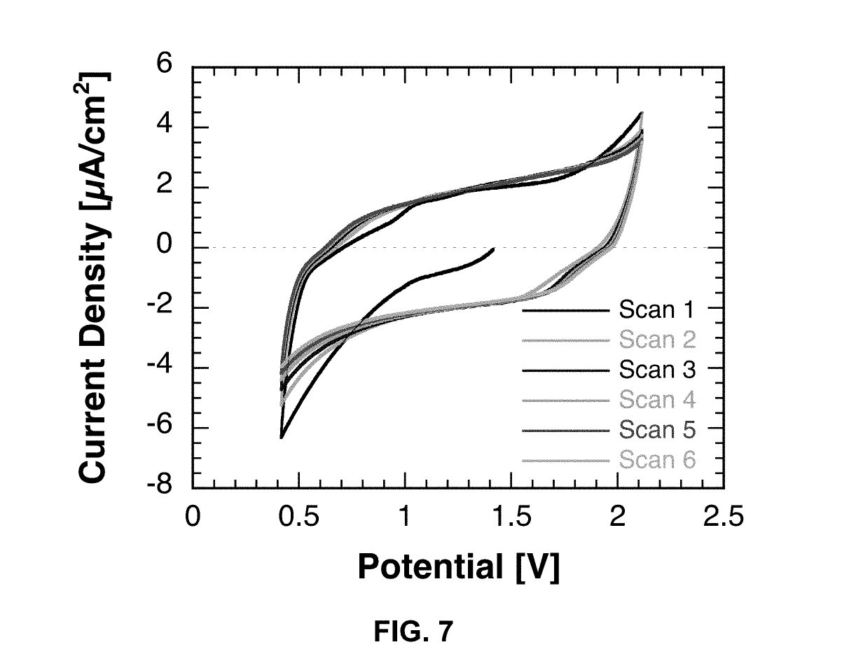

Once determining that sweeping to cathodic potentials leads to the Mg metal deposition onto the anode, only potentials positive of 0 volts were used to study whether or not Mg²⁺ can reversibly diffuse in and out of an NPC host. Three distinct CV behaviors for coin cells were identified that are dependent on the NPC mass density. FIG. 7 shows CV scans for a coin cell fabricated using a similar NPC coating as that shown in FIG. 6, again using an NPC coating with mass density ˜1.0 g/cm³, however now using only positive potentials to prevent Mg metal deposition. First, the current density measurements are ˜100× smaller than those recorded in FIG. 6 which likely resulted in Mg metal deposition. Second, the curves resemble those for a symmetrical double-layer capacitance behavior with a strong potential dependency at the outer boundaries of the scans. Such electrostatic charge and discharge behavior is consistent with that of electrochemical capacitors. See A. J. Bard and L. R. Faulkner, Electrochemical Methods: Fundamentals and Applications, 2^{nd} ed., John Wiley & Sons, Inc. New York, NY (2001). The initial OCP of 1.37 V vs. Mg:Mg²⁺ drifted positive to 1.95 V after a full cycle. The cathodic current density decreases for each successive scan, inferring reduced Mg deposition. These CV scans are not consistent with Mg²⁺ intercalation into an NPC host with density ˜1 g/cm³, which corresponds to an average interplanar spacing between the graphene sheet fragments of 4.6±0.2 Å. See M. P. Siegal et al., Langmuir 20, 1194 (2004).

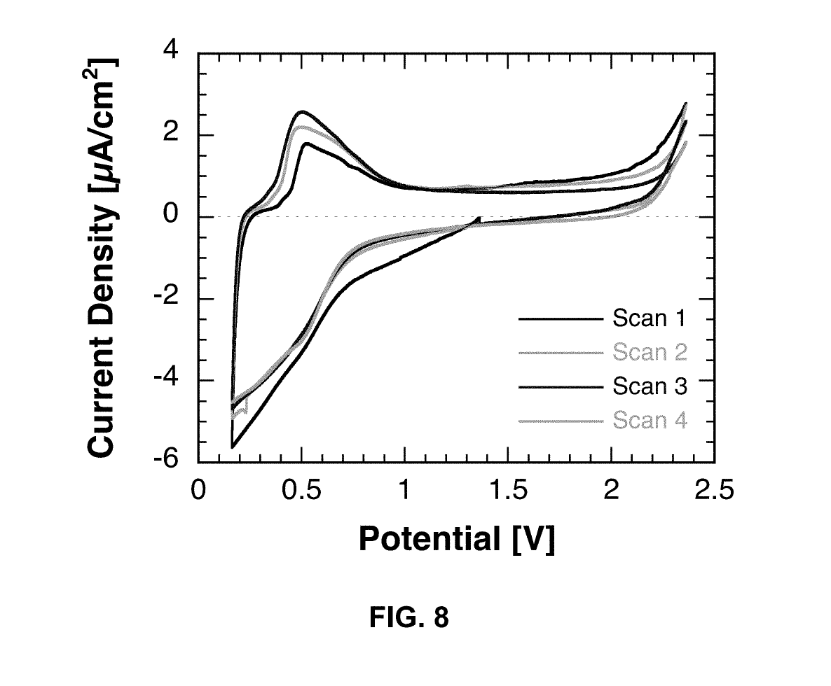

FIG. 8 shows CV scans for an NPC coated anode with mass density ˜0.5 g/cm³, about half that of the previous samples. To maintain the same total carbon areal density, this coating is twice as thick as the denser coating. A lower scan rate of 0.1 mV/s was used to insure that the coating time had enough time to equilibrate. The initial OCP of this coin cell was 1.37 V and shifts positive toward 1.7 V following a full cycle. The shape of the cathodic portion of the scan to lower potentials is expected for Mg-ion insertion into a host material, with insertion becoming noticeable near 0.7 V and increasing as a function of potential. See D. Aurbach et al., The Chemical Record 3, 61 (2003). De-insertion peaks are observed near 0.5 V and increase with each successive cycle. The insertion behavior is very reproducible following the initial scan. These CV scans are consistent with behavior anticipated for nearly reversible intercalation of Mg²⁺ into an NPC host material in analogy with that observed for Li⁺ or Na⁺ intercalation into other carbon hosts. See E. Pollak et al., Nano Lett. 10, 3386 (2010); and C. Bommier et al., Carbon 76, 165 (2014). These CV scans all show a similar large increase in the insertion current somewhat above 0 V in the cathodic portion of the scan, and an obvious de-insertion peak at a higher voltage during the anodic portion. Interpolating the density vs. interplanar spacing results from Siegal et al. finds that the average interplanar spacing between the graphene sheet fragments for this mass density is ˜5.0±0.2 Å. See M. P. Siegal et al., Langmuir 20, 1194 (2004).

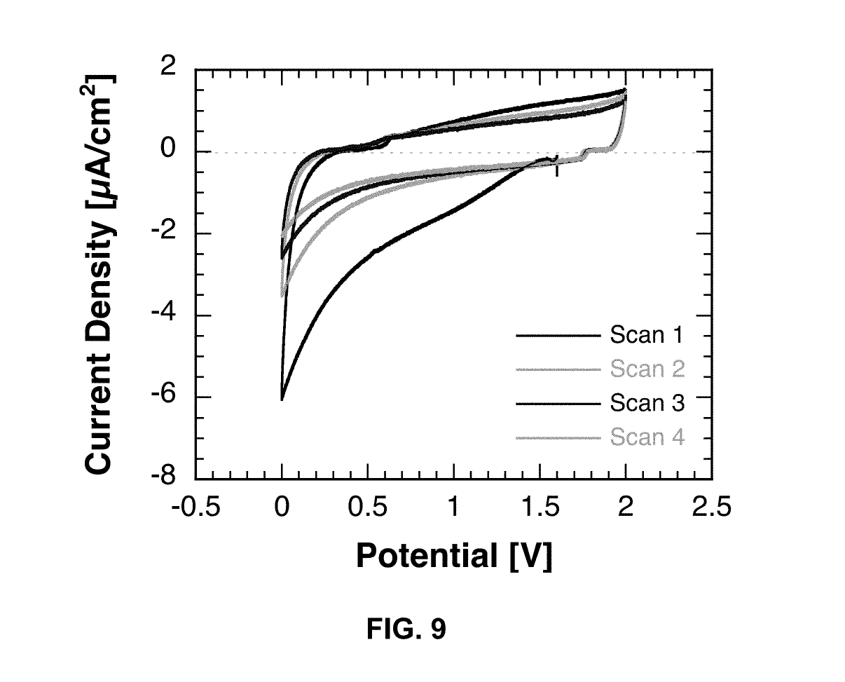

Several coin cells were fabricated with the lowest NPC densities studied, from 0.06 to 0.40 g/cm³, each resulting in nearly identical CV behavior. FIG. 9 shows the CV scans for the lowest density used. Here, the initial OCP was 1.68 V and shifted slightly positive to 1.7 V following full cycling. Mg ion insertion appears to ‘step’ into the NPC matrix with a reproducible, yet very small response at 1.75 V, followed by electrostatic ‘charging’ as a function of decreasing potential. Likewise, a reproducible and small de-insertion appears upon anodic recovery at 0.6 V. As the potential is driven more positive, the electrostatic NPC surface discharges. Successive scans appear to drive decreasing amounts of Mg ions into the NPC, correlating with decreasing removal of Mg ions during de-insertion. These features are present in every coin cell fabricated from NPC films in this density range, which have interplanar spacings >5.2 Å. See M. P. Siegal et al., Langmuir 20, 1194 (2004).

The CV scans shown in FIGS. 7-9 can be further analyzed to determine the energy densities achieved for each cell as a function of NPC mass density and scan cycle, calculated by integrating the region during insertion and/or deposition and multiplying by the given potential for each measured current density. Hence the energy density for the coin cell fabricated using the 1 g/cm³ NPC anode material in FIG. 7 was 7.1 Wh/kg during the initial cycle starting at OCP 1.37 V vs. Mg:Mg²⁺, increasing to 27.1 Wh/kg after a full cycle. However, it is obvious that the energy density decreases with each successive cycle, whereas the anodic stripping appears to be nearly constant after the initial scan.

This implies that fewer Mg ions are depositing with each successive cycle. Assuming that a 4.6±0.2 Å interplanar spacing between the graphene sheet fragments is too small to enable insertion of a partially-solvated Mg-ion, then it is likely that the anodic current density is primarily due to Mg-metal deposition on the NPC top surface. The decreasing current density with additional cycles may be caused by passivation of the surface, or perhaps the formation of a rougher Mg-metal morphology.

The CV scans in FIG. 8 from the 0.5 g/cm³ NPC anode material are indicative of reversible intercalation. The energy density during insertion from the initial OCP scan was 86 Wh/kg and increased to a constant 104 Wh/kg for the ensuing scans. This behavior indicates that equal amounts of charge may be inserting and de-inserting, suggesting a possible reproducible and nearly reversible Mg²⁺ intercalation into an NPC host material with density ˜0.5 g/cm³. Experimental confirmation of intercalation using methods such as x-ray diffraction (XRD) are not useful since NPC is homogeneously disordered to sub-nanometer sizes such that it does not yield any crystalline peaks. This differs from sodium ion intercalation into active hard carbon materials derived from high temperature pyrolysis of sucrose that demonstrate similar CV scan shapes, whereby XRD of such materials exhibit broad peaks typical of disordered carbons. See C. Bommier et al., Carbon 76, 165 (2014). Furthermore, hard carbons demonstrating the best electrochemical capacities have BET surface areas <100 m²/g, compared to ˜1,500 m²/g for NPC. Of significance was the demonstration that lower hard carbon surface areas also result in lower pore volumes while actually increasing the measured capacity due to Na-ion storage. This reduction in pore volume with increasing capacity implies that the capacity likely results from intercalation into the hard carbon. See C. Bommier et al., Carbon 76, 165 (2014). These observations of Na-ion storage into hard carbon and the similarity of the CV scans for Mg-ion storage into NPC infer that intercalation is likely occurring into NPC. If intercalation is occurring for NPC with mass density of 0.5 g/cm³, then this implies that an average interplanar spacing between the graphene sheet fragments ˜5.0±0.2 Å is necessary to enable a partially-solvated Mg-ion to enter.

The scans in FIG. 9 from the 0.06 g/cm³ NPC anode material show yet a different behavior. Here, the energy density from the initial CV scan from OCP was 127 Wh/kg, but plummets to only 10.5 Wh/kg by the third cycle while maintaining a unique step after crossing zero-current density. This degradation of energy density with repeated cycling implies that less Mg is stripping from the NPC with each anodic scan. However, the cause of this effect is unlikely due to the similar stripping of Mg metal using the higher NPC density materials. Recall that the interplanar spacings between graphene sheet fragments for the low-density samples are the widest studied, greater than 5.2 Å; hence transport of partially-solvated Mg ions should not be an issue, assuming that NPC with 5 Å interplanar spacings is sufficient for intercalation. Furthermore, the BET surface area measurements suggested the development of mechanical weakness in these lower density films, as well as the earlier report of acoustic wave dampening. See M. P. Siegal et al., J. Electrochem. Soc. 162, B114 (2015). Therefore, a more likely interpretation of the CV scan performance is due to the mechanical instability of such low density, soft NPC materials. It is plausible such films have initial structural integrity issues, especially given the larger interplanar spacings, and that the mass transport in and out of such materials is sufficient to cause the structure of such NPC materials to degrade with successive cycling.

The combined results of FIGS. 8 and 9 imply requirements about the average interplanar spacing between graphene sheet fragments necessary to enable Mg-ion intercalation into the NPC structure when used in combination with DCC electrolyte. Since the radius of Mg²⁺ is smaller than Li⁺, which readily intercalates into graphitic carbons, it can be assumed that Mg²⁺ does not completely separate from its solvation molecule upon contacting a carbon surface. Typical graphite carbons have an interplanar spacing of 3.4 Å, which is known to be too small for diffusing partially-solvated Mg-ions. The above results suggest that such spacings, or diffusion channels, need to be 5 Å. The incomplete de-solvation of Mg²⁺ from the DCC electrolyte is known, although not well-understood. See H. D. Yoo et al., Energy & Environmental Science 6, 2265 (2013); and L. F. Wan et al., Chem. Mater. 27, 5932 (2015). However, it is expected that at minimum it exists in some MgₓCl_{y}⁺ form, possibly as Mg₂Cl₃⁺. Such a charged molecular ion will be significantly larger than a single Mg²⁺, creating steric limitations for intercalation into a host material. These results infer that a carbon material with enhanced interplanar spacings can possibly act as an anode host material for Mg-ions, included partially-solvated forms. Such knowledge makes development of new electrolyte chemicals for Mg² transport that operate at higher voltages, akin to Li⁺ transport, more relevant.

The present invention has been described as nanoporous-carbon host materials for reversible magnesium ion intercalation. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A rechargeable magnesium battery, comprising:
a positive electrode;
a negative electrode comprising nanoporous carbon; and
an electrolyte for movement of magnesium ions from the positive electrode to the negative electrode during charging and from the negative electrode to the positive electrode during discharging.

2. The rechargeable magnesium battery of claim 1, wherein the nanoporous carbon has a density of greater than 0.4 g/cm³ and less than 1.0 g/cm³.

3. The rechargeable magnesium battery of claim 1, wherein the nanoporous carbon has a BET surface area of greater than 1,200 m²/g and less than 1800 m²/g.

4. The rechargeable magnesium battery of claim 1, wherein the nanoporous carbon has an average interplanar spacing between graphene sheet fragments of greater than 4.8 Å.

5. The rechargeable magnesium battery of claim 1, wherein the positive electrode comprises magnesium metal.

6. The rechargeable magnesium battery of claim 1, wherein the electrolyte comprises magnesium organohaloaluminate.
